(19) United States
(12) Patent Application Publication
(10) Pub. No.: US 2022/0334579 A1
(43) Pub. Date: Oct. 20, 2022

(54) UNMANNED DEVICE CONTROL

(71) Applicant: Beijing Sankuai Online Technology Co., Ltd., Beijing (CN)

(72) Inventors: Jie MA, Beijing (CN); Yu BAI, Beijing (CN); Tao ZHANG, Beijing (CN); Qingshan JIA, Beijing (CN); Shiqi LIAN, Beijing (CN); Mingyu FAN, Beijing (CN); Dongchun REN, Beijing (CN); Huaxia XIA, Beijing (CN)

(21) Appl. No.: 17/666,560

(22) Filed: Feb. 8, 2022

(30) Foreign Application Priority Data
Apr. 14, 2021 (CN) 202110397319.2

(51) Int. Cl. G05D 1/00; G05D 1/02; G05D 1/10; B64C 39/02

(52) U.S. Cl. CPC G05D 1/0088; G05D 1/0214; G05D 1/0223; G05D 1/0238; G05D 1/0246; G05D 1/101; B64C 39/024; B64C 2201/127; B64C 2201/141

(57) ABSTRACT

A method and apparatus for controlling an unmanned device, a storage medium, and an electronic device are provided. In some embodiments, not only a control policy is determined according to a single frame of a current image, but a safety representation value of an unmanned device at a current moment and safety representation values of the unmanned device at respective historical moments are respectively determined according to a current image and environment images of several historical moments. In those embodiments, a control policy of the unmanned device at a next moment is determined according to a safety representation value of the unmanned device at current moment and the safety representation values of the unmanned device at respective historical moments.

### CROSS REFERENCE TO RELATED APPLICATIONS

The present application claims priority to Chinese Patent Application No. 2021103973192, filed on Apr. 14, 2021, which is incorporated herein by reference in its entirety.

### TECHNICAL FIELD

This specification relates to the field of automatic driving technologies, and in particular, to methods and apparatuses for controlling an unmanned device, storage media, and electronic devices.

### BACKGROUND

With the development of automatic driving technologies, the unmanned device plays an increasingly important role in various fields. Generally, the unmanned device needs to autonomously perceive the environment information (such as an obstacle) around the unmanned device, determines a control policy according to the perceived environment information, and finally controls the unmanned device according to the control policy.

At present, the unmanned device generally perceives the environment information by acquiring images around the unmanned device, and determines a control policy according to the acquired images.

However, when determining the control policy, the control policy is usually made according to each frame of image that is independently acquired. As a result, the control policy made according to each frame of image is not smooth and is prone to jumps, reducing the riding comfort of the unmanned device.

### SUMMARY

This disclosure provides a method for controlling an unmanned device, including: acquiring an environment image around an unmanned device at a current moment as a current image; determining a position of one or more obstacles included in the current image; determining a safety representation value of the unmanned device at the current moment according to the position of the one or more obstacles at the current moment and a position of the unmanned device at the current moment; determining a control policy of the unmanned device at a next moment according to the safety representation value of the unmanned device at the current moment and a safety representation value of the unmanned device at at least one historical moment, where the safety representation value of the unmanned device at the at least one historical moment is determined according to an environment image acquired around the unmanned device at the at least one historical moment; and controlling the unmanned device according to the control policy.

This disclosure provides an apparatus for controlling an unmanned device, including: an acquisition module, configured to acquire an environment image around an unmanned device at a current moment as a current image; a recognition module, configured to determine a position of one or more obstacles included in the current image; a safety assessment module, configured to determine a safety representation value of the unmanned device at the current moment according to the position of the one or more obstacles at the current moment and a position of the unmanned device at the current moment; a policy determining module, configured to determine a control policy of the unmanned device at a next moment according to the safety representation value of the unmanned device at the current moment and a safety representation value of the unmanned device at at least one historical moment, where the safety representation value of the unmanned device at the at least one historical moment is determined according to an environment image acquired around the unmanned device at the at least one historical moment; and a control module, configured to control the unmanned device according to the control policy.

This disclosure provides a computer-readable storage medium, storing a computer program, where the computer program, when executed by a processor, implements the method for controlling an unmanned device.

This specification provides an electronic device, including a memory, a processor, and a computer program stored in the memory and capable of being run on the processor, where the processor implements the method for controlling an unmanned device when executing the program.

### BRIEF DESCRIPTION OF THE DRAWINGS

Accompanying drawings described herein are used for providing further understanding about this specification, and constitute a part of this specification. Exemplary embodiments of this specification and descriptions thereof are used for explaining this specification, and do not constitute an inappropriate limitation on this specification.

FIG. 1 is a schematic diagram of a method for controlling an unmanned device according to an embodiment of this specification;

FIG. 2 is a schematic diagram of a region of interest of an unmanned device according to an embodiment of this specification;

FIG. 3 is a schematic diagram of a function in which a travel distance of an unmanned device changes with time according to an embodiment of this specification;

FIG. 4 is a schematic structural diagram of an apparatus for controlling an unmanned device according to an embodiment of this specification; and

FIG. 5 is a schematic structural diagram of an electronic device according to an embodiment of this specification.

### DETAILED DESCRIPTION OF THE EMBODIMENTS

To clearly state the objectives, technical solutions, and advantages of this specification, the technical solutions of this specification will be clearly and completely described below with reference to specific embodiments of this specification and corresponding accompanying drawings. Apparently, the described embodiments are merely some but not all of the embodiments of this specification. All other embodiments obtained by a person of ordinary skill in the art based on the embodiments of this specification without creative efforts shall fall within the protection scope of this specification.

The technical solutions provided in the embodiments of this specification are described in detail below with reference to the accompanying drawings.

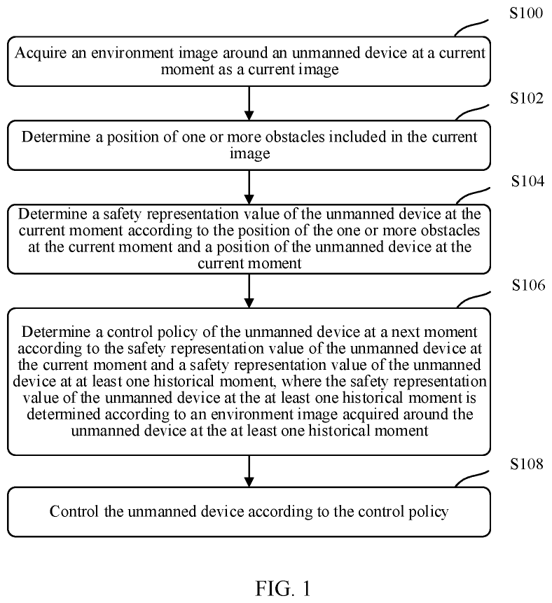

FIG. 1 is a schematic diagram of a method for controlling an unmanned device according to an embodiment of this specification, including step S100 to step S108.

At S100, an environment image around an unmanned device at a current moment is acquire as a current image.

In this embodiment, an image acquisition device may be disposed on the unmanned device. The image acquisition device is configured to acquire the environment image around the unmanned device, to facilitate subsequent control of the unmanned device according to the environment image. The unmanned device described in this specification may be an unmanned delivery device, including an unmanned delivery vehicle and an unmanned aerial vehicle. The unmanned delivery device may be configured to perform a delivery or logistics task, such as a take-out delivery task or an express delivery task.

In this embodiment, the unmanned device may be autonomously controlled by using the method shown in FIG. 1, or the unmanned device may be controlled by another device such as a cloud or a server. The following merely uses an example in which the unmanned device is autonomously controlled by using the method shown in FIG. 1 for description.

The unmanned device may periodically acquire the environment image around the unmanned device according to a preset period by using the image acquisition device. In some embodiments, when an end moment of a current period comes, the image acquisition device acquires the environment image around the unmanned device at the current moment as the current image.

At S102, a position of one or more obstacles included in the current image is determined.

In this embodiment, there are a plurality of methods for determining the position of the obstacles around the unmanned device at the current moment according to the current image. A method for determining a position of an obstacle provided below is merely used as an example. However, a person skilled in the art should understand that this does not constitute a limitation to this specification.

First, the unmanned device may determine the position of the unmanned device at the current moment by using the Global Positioning System (GPS) or a high-precision map, and then determine relative positions of the obstacle and the unmanned device according to an intrinsic parameter of the image acquisition device and image coordinates of the obstacle in the current image, and finally determine the position of the obstacle at the current moment according to the relative positions of the obstacle and the unmanned device and the position of the unmanned device at the current moment.

At S104, a safety representation value of the unmanned device at the current moment is determined according to the position of the one or more obstacles at the current moment and the position of the unmanned device at the current moment.

In this embodiment, after a position of each obstacle at the current moment is determined according to the current image acquired by the image acquisition device, a distance between the unmanned device and each obstacle at the current moment may be determined according to the position of each obstacle at the current moment and the position of the unmanned device at the current moment, and the safety representation value of the unmanned device at the current moment is then determined according to the distance between the unmanned device and each obstacle at the current moment. The safety representation value is used for representing a safety distance between the unmanned device and the obstacle. A higher safety representation value indicates that the unmanned device is safer, and is less likely to collide with the obstacle. A lower safety representation value indicates that the unmanned device is more dangerous, and may be more likely to collide with the obstacle.

In some embodiments, for each obstacle, a safety representation value of the unmanned device corresponding to the obstacle at the current moment may be determined according to the distance between the unmanned device and the obstacle at the current moment, where the distance between the unmanned device and the obstacle is negatively correlated with the safety representation value of the unmanned device corresponding to the obstacle. The safety representation value of the unmanned device at the current moment is then determined according to the safety representation value of the unmanned device corresponding to each obstacle at the current moment. For example, a minimum value of the safety representation values of the unmanned device corresponding to the obstacle at the current moment may be determined as the safety representation value of the unmanned device at the current moment.

Further, when the safety representation value of the unmanned device at the current moment is determined, a safety representation value of the unmanned device in a lateral direction and a safety representation value of the unmanned device in a longitudinal direction may further be determined respectively. The longitudinal direction is a direction from a tail to a head of the unmanned device, and the lateral direction is a direction perpendicular to the longitudinal direction. In some embodiments, for each obstacle, when the safety representation value of the unmanned device relative to the obstacle at the current moment is determined, a distance between the unmanned device at the current moment and the obstacle in the lateral direction and a distance between the unmanned device at the current moment and the obstacle in the longitudinal direction may be determined respectively, a safety representation value of the unmanned device relative to the obstacle in the lateral direction is determined according to the distance between the unmanned device and the obstacle in the lateral direction, a safety representation value of the unmanned device relative to the obstacle in the longitudinal direction is determined according to the distance between the unmanned device and the obstacle in the longitudinal direction, and the safety representation value of the unmanned device relative to the obstacle is then determined according to the safety representation values of the unmanned device relative to the obstacle in the longitudinal direction and the lateral direction respectively. For example, a minimum value of the safety representation values of the unmanned device relative to the obstacle in the longitudinal direction and the lateral direction respectively may be determined as the safety representation value of the unmanned device relative to the obstacle.

The safety representation value of the unmanned device relative to the obstacle in the lateral direction may further be determined according to the distance between the unmanned device and the obstacle in the lateral direction and a minimum lateral safety distance of the unmanned device. For example, the distance between the unmanned device and the obstacle in the lateral direction and the minimum lateral safety distance of the unmanned device are compared, and the safety representation value of the unmanned device relative to the obstacle in the lateral direction is determined according to a comparison result. Similarly, the safety representation value of the unmanned device relative to the obstacle in the longitudinal direction may further be determined according to the distance between the unmanned device and the obstacle in the longitudinal direction and a minimum longitudinal safety distance of the unmanned device. For example, the distance between the unmanned device and the obstacle in the longitudinal direction and the minimum longitudinal safety distance of the unmanned device are compared, and the safety representation value of the unmanned device relative to the obstacle in the longitudinal direction is determined according to a comparison result.

In addition, in an actual application scenario, only some of the obstacles in the current image acquired in step S100 affect the safety of the unmanned device. Therefore, in step S104, the safety representation value of the unmanned device at the current moment may be determined only according to these obstacles. In some embodiments, a current region of interest of the unmanned device may be determined according to a current speed of the unmanned device. The current region of interest includes the position of the unmanned device at the current moment, and an area of the current region of interest is positively correlated with the current speed of the unmanned device. The safety representation value of the unmanned device at the current moment is determined according to a position of one or more obstacles that are in the current region of interest and the position of the unmanned device at the current moment.

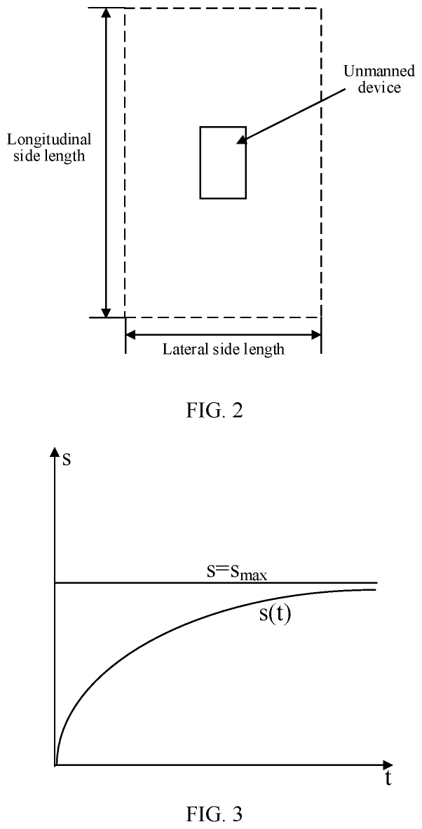

As shown in FIG. 2, a dashed-line range is a region of interest of the unmanned device. A lateral side length of the region of interest may be fixed, and a longitudinal side length may be dynamically adjusted according to a speed of the unmanned device at the current moment. A higher speed indicates a larger longitudinal side length. The lateral side length and the longitudinal side length of the region of interest may alternatively be fixed.

At S106, a control policy of the unmanned device at a next moment is determined according to the safety representation value of the unmanned device at the current moment and a safety representation value of the unmanned device at at least one historical moment, where the safety representation value of the unmanned device at the at least one historical moment is determined according to an environment image acquired around the unmanned device at the at least one historical moment.

In this embodiment, the same method for determining the safety representation value of the unmanned device at the current moment according to the current image acquired at the current moment may be adopted to determine the safety representation value of the unmanned device at the historical moment according to the environment image (hereinafter referred to as a historical image) acquired at the historical moment.

The image acquisition device on the unmanned device acquires the environment image according to a set period. Therefore, each time the image acquisition device acquires an environment image, step S104 may be performed to determine the safety representation value of the unmanned device when the environment image is acquired. After the safety representation value is determined, the safety representation value and a moment when the environment image is acquired are correspondingly stored, so as to directly read the stored safety representation values at respective historical moments when determining the control policy in step S106.

After the safety representation value of the unmanned device at the current moment is determined and the stored safety representation values of the unmanned device at respective historical moments are read, a quantity of safety representation values in the safety representation values that are less than a preset threshold may be determined, and the control policy of the unmanned device at the next moment is determined according to the quantity.

In some embodiments, a historical time period may be determined by using the current moment as an end point of the historical time period and a time length as a specified time length, and the safety representation values of the unmanned device at respective historical moments in the historical time period are read.

For example, assuming that the current moment is to, and a period of acquiring the environment image by the image acquisition device is T, the specified duration may be 9T, and a total of nine historical moments are t₋₉, t₋₈, t₋₇, . . . , and t₋₁. Safety representation values at the nine historical moments may be read and denoted as S₋₉, S₋₈, S-₋₇, . . . , and S₋₁, and there is a total of 10 safety representation values by adding a safety representation value S₀ at the current moment. Subsequently, a quantity of safety representation values in the 10 safety representation values that are less than the preset threshold may be determined.

In this embodiment of this specification, an acceleration of the unmanned device at the next moment may be determined when the control policy of the unmanned device at the next moment is determined. The acceleration described in this embodiment of this specification may include an acceleration in a direction opposite to a current driving direction of the unmanned device, that is, a reverse acceleration, which may also be referred to as a deceleration.

As shown in Table 1, a correspondence between the quantity of the safety representation values that are less than the preset threshold and the acceleration may be preset.

TABLE 1

| Quantity of safety representation values | |
|---|---|
| that are less than a preset threshold | Acceleration |
| n₀ | 0 |
| n₁ | a₁ |
| n₂ | a₂ |
| n₃ | a₃ |

In Table 1, n₃>n₂>n₁>n₀, the acceleration is a scalar without a symbol (that is, without a direction), and a₃>a₂ >a₁>0. That is, when the direction of the acceleration is opposite to the driving direction of the unmanned device, the larger quantity of safety representation values that are less than the preset threshold indicates a greater acceleration.

Further, after the safety representation values of the unmanned device at respective historical moments are read, the safety representation values of the unmanned device at respective historical moments and the safety representation value of the unmanned device at the current moment are ranked in chronological order, and a quantity of safety representation values that are consecutively less than the preset threshold is determined according to the ranked safety representation values. Subsequently, the acceleration of the unmanned device at the next moment may be determined according to the quantity of safety representation values that are consecutively less than the preset threshold.

The above is described by using an example in which the acceleration of the unmanned device at the next moment is determined based on given rules (such as the rules shown in Table 1), and the acceleration of the unmanned device at the next moment may alternatively be determined based on a machine learning model.

In some embodiments, the safety representation values of the unmanned device at respective historical moments may be read by using the foregoing same method, the safety representation values of the unmanned device at respective historical moments and the safety representation value of the unmanned device at the current moment are ranked in chronological order, a feature of the unmanned device at the current moment is determined according to the ranked safety representation values, and the feature is inputted into a pre-trained decision- making model, to obtain the acceleration of the unmanned device at the next moment outputted by the decision-making model.

When the feature of the unmanned device at the current moment is determined, in addition to determining the feature of the unmanned device at the current moment according to the ranked safety representation values, the feature of the unmanned device at the current moment may alternatively be determined according to speeds and accelerations of the unmanned device and each obstacle at the current moment, a lateral distance between the unmanned device and each obstacle, and a longitudinal distance between the unmanned device and each obstacle.

The above example continues to be used. The safety representation values read at the nine historical moments are denoted as S₋₉, S₋₈, S₋₇, . . . , and S₋₁, and there is the total of 10 safety representation values by adding the safety representation value S₀ at the current moment. The 10 safety representation values ranked in chronological order are S₋₉, S₋₈, S-₋₇, . . . S₋₁, and S₀. Assuming that a current speed of the unmanned device is V₀, a current speed of the obstacle is V₁, an acceleration of the unmanned device at the current moment is a₀, a current acceleration of the obstacle is b₁, a lateral distance between the unmanned device and the obstacle is d1, and a longitudinal distance is ds, a vector [S₋₉, S-₋₈, S-₋₇, . . . , S₋₁, S₀, V₀, V₁, a₀, b₁, dl, ds] may be determined as a feature vector used for representing the feature of the unmanned device at the current moment. Subsequently, the feature vector may be inputted into the pre-trained decision-making model, to obtain the acceleration of the unmanned device at the next moment outputted by the decision-making model.

At S108, the unmanned device is controlled according to the control policy.

After the acceleration of the unmanned device at the next moment is determined by using the foregoing step S106, the unmanned device may directly control the unmanned device to travel at the determined acceleration at the next moment, that is, may directly send the determined acceleration to a control module inside the unmanned device for controlling the driving of the unmanned device, so that the control module directly controls the unmanned device to travel at the determined acceleration at the next moment.

In the foregoing method, not only the control policy is determined according to a single frame of a current image, but the safety representation value of the unmanned device at the current moment and the safety representation values of the unmanned device at a plurality of historical moments are respectively determined according to the current image and environment images at several historical moments, and control policies of the unmanned device at the next moment are then determined according to a safety representation value of the unmanned device at current moment and the safety representation values of the unmanned device at the plurality of historical moments, so that the determined control policies are smoother without jumping. When the unmanned device performs autonomous control according to the determined control policies, the riding comfort may be improved.

Further, the control method of directly controlling the unmanned device to travel at the determined acceleration at the next moment may still cause a driving state of the unmanned device to be unsmooth, jumps may occur, and the riding comfort may be reduced. Therefore, to further improve smoothness of driving of the unmanned device, in this embodiment of this specification, a maximum driving distance of the unmanned device may be determined according to the acceleration of the unmanned device at the next moment in step S106, and the unmanned device is controlled according to the maximum travelable distance and a current speed of the unmanned device.

Because the direction of the acceleration determined in this embodiment is opposite to a current driving direction of the unmanned device, in a condition that the unmanned device travels with uniform acceleration at the current speed and the determined acceleration, and when a driving speed of the unmanned device drops to 0, a distance traveled by the unmanned device is determined as the maximum driving distance. That is, the maximum driving distance s=v²/2a, where v is the current speed of the unmanned device, and a is the acceleration of the unmanned device at the next moment determined in step S106.

In other embodiments, the maximum driving distance may alternatively be determined by using another method, for example, the maximum driving distance s=v²/3a or s=v²/4a.

After the maximum driving distance is determined, a driving speed of the unmanned device at the next moment may be determined according to the maximum driving distance and the current speed of the unmanned device, and the unmanned device is controlled according to the driving speed of the unmanned device at the next moment.

In some embodiments, the maximum driving distance and a driving speed of the unmanned device at the current moment may be inputted into a preset track planning model. The track planning model plans a driving track for the unmanned device at the next moment based on a constraint that a travel distance of the unmanned device does not exceed the maximum driving distance and there is no jump in the driving state of the unmanned device, to obtain the driving speed of the unmanned device at the next moment, and the unmanned device is controlled at the driving speed of the unmanned device at the next moment.

As shown in FIG. 3, the constraint that there is no jump in the driving state of the unmanned device may be expressed mathematically that there is a first-order continuous derivative in a function in which the travel distance of the unmanned device changes with time.

FIG. 3 is a schematic diagram of a function in which a travel distance of an unmanned device changes with time according to an embodiment of this specification. In FIG. 3, a vertical coordinate represents a travel distance s of the unmanned device, a horizontal coordinate represents a time t, and the function in which the travel distance of the unmanned device changes with time is an s(t) curve in this coordinate. The constraint that the travel distance of the unmanned device does not exceed the maximum driving distance means that the s(t) curve is below s=sₘₐₓ, and sₘₐₓ is the maximum driving distance. The constraint that there is no jump in the driving state of the unmanned device means that the s(t) curve has a first-order continuous derivative. Therefore, a smooth s(t) curve below s=sₘₐₓ can be planned, so that the driving speed of the unmanned device at the next moment can be obtained according to this smooth s(t) curve.

The above is the method for controlling an unmanned device provided in the embodiments of this specification. Based on the same idea, this specification further provides a corresponding apparatus, a storage medium, and an electronic device.

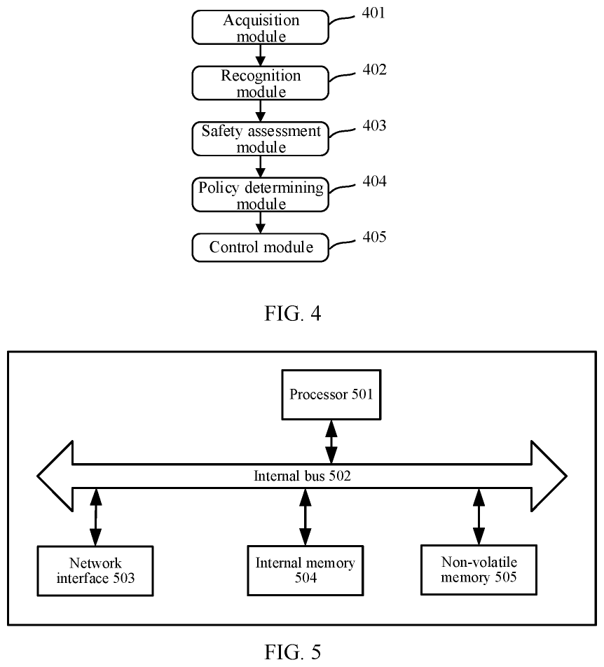

FIG. 4 is a schematic structural diagram of an apparatus for controlling an unmanned device according to an embodiment of this specification. The apparatus includes: an acquisition module 401, configured to acquire an environment image around an unmanned device at a current moment as a current image; a recognition module 402, configured to determine a position of one or more obstacles included in the current image; a safety assessment module 403, configured to determine a safety representation value of the unmanned device at the current moment according to the position of the one or more obstacles at the current moment and a position of the unmanned device at the current moment; a policy determining module 404, configured to determine a control policy of the unmanned device at a next moment according to the safety representation value of the unmanned device at the current moment and a safety representation value of the unmanned device at at least one historical moment, where the safety representation value of the unmanned device at the at least one historical moment is determined according to an environment image acquired around the unmanned device at the at least one historical moment; and a control module 405, configured to control the unmanned device according to the control policy.

In some embodiments, the safety assessment module 403 is configured to determine a current region of interest of the unmanned device according to a current speed of the unmanned device, where the current region of interest includes the position of the unmanned device at the current moment, and an area of the current region of interest is positively correlated with the current speed of the unmanned device; and determine the safety representation value of the unmanned device at the current moment according to a position of one or more obstacles that are in the current region of interest and the position of the unmanned device at the current moment.

In some embodiments, the policy determining module 404 is configured to determine a historical time period by using the current moment as an end point of the historical time period and a time length as a specified duration; determine, according to safety representation values of the unmanned device at respective historical moments in the historical time period and the safety representation value of the unmanned device at the current moment, a quantity of safety representation values that are less than a preset threshold; and determine an acceleration of the unmanned device at the next moment according to the quantity of safety representation values that are less than the preset threshold.

In some embodiments, the policy determining module 404 is configured to rank the safety representation values of the unmanned device at respective historical moments in the historical time period and the safety representation value of the unmanned device at the current moment in a chronological order; and determining, according to the ranked safety representation values, a quantity of safety representation values that are consecutively less than the preset threshold.

In some embodiments, the policy determining module 404 is configured to determine a historical time period by using the current moment as an end point of the historical time period and a time length as a specified duration; rank safety representation values of the unmanned device at respective historical moments in the historical time period and the safety representation value of the unmanned device at the current moment in a chronological order; determine a feature of the unmanned device at the current moment according to the ranked safety representation values; and input the feature into a pre-trained decision-making model, to obtain an acceleration of the unmanned device at the next moment outputted by the decision-making model.

In some embodiments, the control module 405 is configured to determine a maximum driving distance of the unmanned device according to the acceleration of the unmanned device at the next moment; and control the unmanned device according to the maximum driving distance and a current speed of the unmanned device.

In some embodiments, the control module 405 is configured to determine a driving speed of the unmanned device at the next moment according to the maximum driving distance and the current speed of the unmanned device; and control the unmanned device according to the driving speed of the unmanned device at the next moment.

This specification further provides a computer-readable storage medium, storing a computer program, where the computer program, when executed by a processor, may be configured to implement the method for controlling an unmanned device provided above.

Based on the method for controlling an unmanned device, the embodiments of this specification further provide a schematic structural diagram of an electronic device shown in FIG. 5. As shown in FIG. 5, at the hardware level, the unmanned device includes a processor 501, an internal bus 502, a network interface 503, an internal memory 504, and a non-volatile memory 505, and certainly may further include hardware required for other services. The processor reads a corresponding computer program from the non-volatile memory into the internal memory and then runs the computer program, to implement the method for controlling an unmanned device.

In addition to a software implementation, this specification does not exclude other implementations, for example, a logic device or a combination of software and hardware. In other words, an entity executing the following processing procedure is not limited to the logic units, and may also be hardware or logic devices.

In the 1990s, improvements of a technology can be clearly distinguished between hardware improvements (for example, improvements to a circuit structure such as a diode, a transistor, or a switch) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. Moreover, nowadays, instead of manually making integrated circuit chips, this programming is mostly implemented by using “logic compiler” software, which is similar to the software compiler used in program development and writing. The original code is written in a specific programming language before compiling, and this language is referred to as a hardware description language (HDL). There are various kinds of HDLs, for example, advanced Boolean expression language (ABEL), altera hardware description language (AHDL), Confluence, Cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that provided that a method procedure is logically programmed and then programmed to an integrated circuit by using the foregoing hardware description languages, a hardware circuit that implements the logical method procedure can be easily obtained.

A controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20, and Silicone Labs C8051F320. The memory controller can also be implemented as part of the memory control logic. A person skilled in the art will also appreciate that, in addition to implementing the controller in the form of pure computer- readable program code, it is also possible to implement, by logically programming the method steps, the controller in the form of a logic gate, switch, application-specific integrated circuit, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module, or the unit described in the foregoing embodiments may be implemented by a computer chip or an entity, or implemented by a product having a certain function. Atypical implementation device is a computer. The computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, during implementation of this specification, the functions of the units may be implemented in the same piece of or a plurality of pieces of software and/or hardware.

A person skilled in the art should understand that the embodiments of this specification may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a compact disc read-only memory (CD-ROM), an optical memory, and the like) that include computer-usable program code.

This specification is described with reference to the flowcharts and/or block diagrams of the method, the device (system), and the computer program product according to the embodiments of this specification. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special- purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can instruct a computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and an internal memory.

The internal memory may include a form such as a volatile memory, a random-access memory (RAM) and/or a non-volatile memory such as a read-only memory (ROM) or a flash RAM in a computer-readable medium. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of the storage medium of the computer include, but are not limited to, a phase-change memory (PRAM), a static random access memory (SRAM), a dynamic random access memory (DRAM), or other types of random access memory (RAM), a read-only memory (ROM), an erasable programmable read-only memory (EEPROM), a flash memory or another storage technology, a CD-ROM, a digital versatile disc (DVD) or another optical storage, a cartridge tape, a magnetic tape, a magnetic disk storage or another magnetic storage device, or any other non-transmission medium, which may be configured to store information accessible by a computing device. According to limitations of this specification, the computer-readable medium does not include transitory computer-readable media, such as a modulated data signal and a modulated carrier.

It should be further noted that the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “include a/an . . . ” does not exclude other same elements existing in the process, the method, the article, or the device that includes the element.

A person skilled in the art should understand that the embodiments of this specification may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a CD-ROM, an optical memory, and the like) that include computer-usable program code.

This specification can be described in the general context of computer-executable instructions executed by a computer, for example, program modules. Generally, the program module includes a routine, a program, an object, a component, a data structure, and the like for executing a particular task or implementing a particular abstract data type. This specification may also be implemented in a distributed computing environment in which tasks are performed by remote processing devices connected by using a communication network. In a distributed computing environment, the program module may be located in both local and remote computer storage media including storage devices.

The embodiments of this specification are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The descriptions are merely embodiments of this specification, and are not intended to limit this specification. For a person skilled in the art, various modifications and changes may be made to this specification. Any modification, equivalent replacement, and improvement made within the spirit and principle of this specification shall fall within the scope of the claims of this specification.

1. A method for controlling an unmanned device, comprising:
acquiring an environment image around an unmanned device at a current moment as a current image;
determining a position of one or more obstacles comprised in the current image;
determining a safety representation value of the unmanned device at the current moment according to the position of the one or more obstacles at the current moment and a position of the unmanned device at the current moment;
determining a control policy of the unmanned device at a next moment according to the safety representation value of the unmanned device at the current moment and a safety representation value of the unmanned device at at least one historical moment, wherein the safety representation value of the unmanned device at the at least one historical moment is determined according to an environment image acquired around the unmanned device at the at least one historical moment; and
controlling the unmanned device according to the control policy.

2. The method according to claim 1, wherein determining the safety representation value of the unmanned device at the current moment according to the position of the one or more obstacles at the current moment and the position of the unmanned device at the current moment comprises:
determining a current region of interest of the unmanned device according to a current speed of the unmanned device, wherein the current region of interest comprises the position of the unmanned device at the current moment, and an area of the current region of interest is positively correlated with the current speed of the unmanned device; and
determining the safety representation value of the unmanned device at the current moment according to a position of one or more obstacles that are in the current region of interest and the position of the unmanned device at the current moment.

3. The method according to claim 1, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
determining, according to safety representation values of the unmanned device at respective historical moments in the historical time period and the safety representation value of the unmanned device at the current moment, a quantity of safety representation values that are less than a preset threshold; and
determining an acceleration of the unmanned device at the next moment according to the quantity of safety representation values that are less than the preset threshold.

4. The method according to claim 3, wherein determining, according to the safety representation values of the unmanned device at respective historical moments in the historical time period and the safety representation value of the unmanned device at the current moment, the quantity of safety representation values that are less than the preset threshold comprises:
ranking the safety representation values of the unmanned device at respective historical moments in the historical time period and the safety representation value of the unmanned device at the current moment in a chronological order; and
determining, according to ranked safety representation values, the quantity of safety representation values that are consecutively less than the preset threshold.

5. The method according to claim 1, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
ranking safety representation values of the unmanned device at respective historical moments in the historical time period and the safety representation value of the unmanned device at the current moment in a chronological order;
determining a feature of the unmanned device at the current moment according to ranked safety representation values; and
inputting the feature into a pre-trained decision-making model, to obtain an acceleration of the unmanned device at the next moment outputted by the pre-trained decision-making model.

6. The method according to claim 3, wherein controlling the unmanned device according to the control policy comprises:
determining a maximum driving distance of the unmanned device according to the acceleration of the unmanned device at the next moment; and
controlling the unmanned device according to the maximum driving distance and a current speed of the unmanned device.

7. The method according to claim 6, wherein controlling the unmanned device according to the maximum driving distance and the current speed of the unmanned device comprises:
determining a driving speed of the unmanned device at the next moment according to the maximum driving distance and the current speed of the unmanned device; and
controlling the unmanned device according to the driving speed of the unmanned device at the next moment.

8. An electronic device, comprising:
a memory,
a processor, and
a computer program stored in the memory and capable of being run on the processor, wherein when executing the program, the processor implements operations comprising:
acquiring an environment image around an unmanned device at a current moment as a current image;
determining a position of one or more obstacles comprised in the current image;
determining a safety representation value of the unmanned device at the current moment according to the position of the one or more obstacles at the current moment and a position of the unmanned device at the current moment;
determining a control policy of the unmanned device at a next moment according to the safety representation value of the unmanned device at the current moment and a safety representation value of the unmanned device at at least one historical moment, wherein the safety representation value of the unmanned device at the at least one historical moment is determined according to an environment image acquired around the unmanned device at the at least one historical moment; and
controlling the unmanned device according to the control policy.

9. The electronic device according to claim 8, wherein determining the safety representation value of the unmanned device at the current moment according to the position of the one or more obstacles at the current moment and the position of the unmanned device at the current moment comprises:
determining a current region of interest of the unmanned device according to a current speed of the unmanned device, wherein the current region of interest comprises the position of the unmanned device at the current moment, and an area of the current region of interest is positively correlated with the current speed of the unmanned device; and
determining the safety representation value of the unmanned device at the current moment according to a position of one or more obstacles that are in the current region of interest and the position of the unmanned device at the current moment.

10. The electronic device according to claim 8, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
determining, according to safety representation values of the unmanned device at respective historical moments in the historical time period and the safety representation value of the unmanned device at the current moment, a quantity of safety representation values that are less than a preset threshold; and
determining an acceleration of the unmanned device at the next moment according to the quantity of safety representation values that are less than the preset threshold.

11. The electronic device according to claim 10, wherein determining, according to the safety representation values of the unmanned device at respective historical moments in the historical time period and the safety representation value of the unmanned device at the current moment, the quantity of safety representation values that are less than the preset threshold comprises:
ranking the safety representation values of the unmanned device at respective historical moments in the historical time period and the safety representation value of the unmanned device at the current moment in a chronological order; and
determining, according to ranked safety representation values, the quantity of safety representation values that are consecutively less than the preset threshold.

12. The electronic device according to claim 8, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
ranking safety representation values of the unmanned device at respective historical moments in the historical time period and the safety representation value of the unmanned device at the current moment in a chronological order;
determining a feature of the unmanned device at the current moment according to ranked safety representation values; and
inputting the feature into a pre-trained decision-making model, to obtain an acceleration of the unmanned device at the next moment outputted by the pre-trained decision-making model.

13. The electronic device according to claim 10, wherein controlling the unmanned device according to the control policy comprises:
determining a maximum driving distance of the unmanned device according to the acceleration of the unmanned device at the next moment; and
controlling the unmanned device according to the maximum driving distance and a current speed of the unmanned device.

14. The electronic device according to claim 13, wherein controlling the unmanned device according to the maximum driving distance and the current speed of the unmanned device comprises:
determining a driving speed of the unmanned device at the next moment according to the maximum driving distance and the current speed of the unmanned device; and
controlling the unmanned device according to the driving speed of the unmanned device at the next moment.

15. A non-transient computer-readable storage medium, storing a computer program, wherein the computer program, when executed by a processor, implements operations comprising:
acquiring an environment image around an unmanned device at a current moment as a current image;
determining a position of one or more obstacles comprised in the current image;
determining a safety representation value of the unmanned device at the current moment according to the position of the one or more obstacles at the current moment and a position of the unmanned device at the current moment;
determining a control policy of the unmanned device at a next moment according to the safety representation value of the unmanned device at the current moment and a safety representation value of the unmanned device at at least one historical moment, wherein the safety representation value of the unmanned device at the at least one historical moment is determined according to an environment image acquired around the unmanned device at the at least one historical moment; and
controlling the unmanned device according to the control policy.

16. The non-transient computer-readable storage medium according to claim 15, wherein determining the safety representation value of the unmanned device at the current moment according to the position of the one or more obstacles at the current moment and the position of the unmanned device at the current moment comprises:
determining a current region of interest of the unmanned device according to a current speed of the unmanned device, wherein the current region of interest comprises the position of the unmanned device at the current moment, and an area of the current region of interest is positively correlated with the current speed of the unmanned device; and
determining the safety representation value of the unmanned device at the current moment according to a position of one or more obstacles that are in the current region of interest and the position of the unmanned device at the current moment.

17. The non-transient computer-readable storage medium according to claim 15, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
determining, according to safety representation values of the unmanned device at respective historical moments in the historical time period and the safety representation value of the unmanned device at the current moment, a quantity of safety representation values that are less than a preset threshold; and
determining an acceleration of the unmanned device at the next moment according to the quantity of safety representation values that are less than the preset threshold.

18. The non-transient computer-readable storage medium according to claim 17, wherein determining, according to the safety representation values of the unmanned device at respective historical moments in the historical time period and the safety representation value of the unmanned device at the current moment, the quantity of safety representation values that are less than the preset threshold comprises:
ranking the safety representation values of the unmanned device at respective historical moments in the historical time period and the safety representation value of the unmanned device at the current moment in a chronological order; and
determining, according to ranked safety representation values, the quantity of safety representation values that are consecutively less than the preset threshold.

19. The non-transient computer-readable storage medium according to claim 15, wherein determining the control policy of the unmanned device at the next moment according to the safety representation value of the unmanned device at the current moment and the safety representation value of the unmanned device at the at least one historical moment comprises:
determining a historical time period by using the current moment as an end point of the historical time period and a time length as a specified duration;
ranking safety representation values of the unmanned device at respective historical moments in the historical time period and the safety representation value of the unmanned device at the current moment in a chronological order;
determining a feature of the unmanned device at the current moment according to ranked safety representation values; and
inputting the feature into a pre-trained decision-making model, to obtain an acceleration of the unmanned device at the next moment outputted by the pre-trained decision-making model.

20. The non-transient computer-readable storage medium according to claim 17, wherein controlling unmanned device according to the control policy comprises:
determining a maximum driving distance of the unmanned device according to the acceleration of the unmanned device at the next moment; and
controlling the unmanned device according to the maximum driving distance and a current speed of the unmanned device.
